(19) United States
(12) Patent Application Publication
(10) Pub. No.: US 2024/0111993 A1
(43) Pub. Date: Apr. 4, 2024

(54) OBJECT STORE OFFLOADING

(71) Applicant: HEWLETT PACKARD ENTERPRISE DEVELOPMENT LP, Houston, TX (US)

(72) Inventors: DARIO KOROLIJA, Zurich (CH); Kun Wu, Champaing, IL (US); Sai Rahul Chalamalasetti, Milpitas, CA (US); Lance Mackimmie Evans, Longmont, CO (US); Dejan S. Milojicic, Milpitas, CA (US)

(21) Appl. No.: 17/958,189

(22) Filed: Sep. 30, 2022

(51) Int. Cl. G06N 3/04; G06F 16/2455; G06F 16/28; G06N 3/08

(52) U.S. Cl. CPC G06N 3/0445; G06F 16/24552; G06F 16/288; G06N 3/08

(57) ABSTRACT

Systems and methods are provided for performing object store offloading. A user query can be received from a client device to access a data object. The semantic structure associated with the data object can be identified, as well as one or more relationships associated with the semantic structure of the data object. A view of the data object can be determined based on the one or more relationships and said view can be provided to a user interface.

### BACKGROUND

Disaggregated memory systems use network-attached memory that is distinct from the memory in compute nodes. These systems use a form of scale-out storage built with one or a plurality of storage devices that serve as a pool of storage that can be allocated to any server on a network. The disaggregation decouples memory from compute servers and enables applications to access both local and remote memories. Disaggregation may involve separating computation components and storage and/or separating memory and compute. The separation of memory and compute can occur through disaggregated dynamic random access memory (DRAM), disaggregating persistent memory, far memory, and smart remote memory.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates an example system interacting with a client device in accordance with various examples.

FIG. 2 illustrates an example offload engine in accordance with various examples.

FIG. 3 illustrates an example architecture to implement the systems and methods of the present disclosure.

FIG. 4 illustrates an example operator stack to implement the systems and methods of the present disclosure.

FIG. 5 illustrates an example method to be executed by a computing component in accordance with the systems and methods of the present disclosure.

FIG. 6 is an example computing component that may be used to implement various features of embodiments described in the present disclosure.

The figures are not exhaustive and do not limit the present disclosure to the precise form disclosed.

### DETAILED DESCRIPTION

Historically, databases have relied on keeping more data in the memory near or in the compute nodes to reduce the amount of I/O overheads, i.e. the amount of time spent waiting for input/output operations to complete. I/O overheads arise when the rate at which data is requested is higher than the rate at which it can be delivered. To remedy this, more data is stored in local fast memory which provides faster random access times. That is, by storing more data in this memory, the amount of I/O operations, i.e. the amount of costly accesses to slower storage devices, decreases because the data is more readily available. Additionally, larger sequential accesses to storage (where more blocks of data are moved) are possible that can range from page sizes to processor cache sizes. This can avoid the I/O overheads of multiple smaller accesses due to the decreased number of expensive seek operations, i.e. operations to retrieve selective and filtered blocks of data. This data can be stored in a dynamic random access memory (DRAM) which stores the data in memory cells in a two-dimensional grid. However, adding local memory to reduce these overheads is only a temporary solution because the data to be processed increases while DRAM capacity cannot practically increase enough to accommodate the increasing data. The use of smart disaggregated memory can alleviate these issues by further reducing the overall data movement. Data operators can be moved to the smart disaggregated memory. The data operators can process data as it is read from the smart disaggregated memory to reduce the amount of data that ultimately needs to be moved to the compute node for processing. Processing, in some examples, may be performed directly in the smart memory as opposed to the compute node. As an example, a selection operator may select data based on particular attributes so that only the relevant data is forwarded from the disaggregated memory. This means that, processing nodes receive only the relevant data. Different data operators can be chained together in an operator pipeline, where the operator pipeline can serve a range of client queries, and can act as a processor for the data. All of this reduces memory requirements and difficult provisioning of memory for computing nodes. This is accomplished by situating the processing memory with the smart disaggregated memory and removing unnecessary copying of the data to the compute nodes. This way, only the relevant, processed data is forwarded. This also reduces the usage of network bandwidth. Further, processing of data by these operators can greatly increase the performance, as portions of the queries are offloaded in the smart disaggregated memory to specialized operators designed to exploit pipelining with minimal added processing overhead.

The systems and methods described herein use smart disaggregated memory to delegate operators to an object store, to analyze data to further offload memory requirements and optimize views of data objects. Offloading memory requirements refers to the transfer of resource-intensive tasks to a separate memory. Offloading can be used to move logic from another computer to a dedicated chip as a form of acceleration, to prevent computations that may not be possible to execute due to the lack of resources, or may be difficult to compute in a timely fashion. Using disaggregated memory, tasks can be apportioned to separate memory components to reduce the burden on a particular component. Using various machine learning (ML) models, the system can discover patterns to optimize views of the structure of data. The system disclosed herein can receive a user query from a client device to access a data object. The system can identify the semantic structure associated with the requested data object and can identify one or more relationships associated with the semantic structure of the data object. Based on the one or more relationships, the system can determine a view of the data object and provide that view to a user interface to access the data.

It should be understood that there have been attempts to optimize data access performance, but such attempts are limited by the fact that the semantics related to the accessing of data are ignored or not understood. For example, some prior solutions offload operators, but in doing so, leverage a flat memory model which requires a client application to define the boundaries of data to be processed. Other solutions provide server-side data structure and client semantic information to access that server-side data structure, but fail to provide a way for server-side operations to process the data structures and semantics to reduce the data. Still other current solutions that do provide local processing of structured data, nevertheless cannot scale (expand implementation) across a network to distributed clients, nor do they offload operators acting on those data structures. Accordingly, as noted above, examples of the technologies disclosed herein are not only able to determine the semantics of data but can also process the semantics to optimize input/output operations. Thus, examples are able to offload object store access while understanding object characteristics, i.e., data and semantics, and scaling object store access is made possible.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other approaches, designs, settings, or parameters.

In operation, examples can store a plurality of data objects having various internal structures (i.e. linear and non-linear data structures) and semantics of access (i.e., precompute requirements and other access features). Internal structures may comprise linear data structures such as array, stack, and queue data structures, or may comprise non-linear data structures such as graph or tree data structures and pointer-based data structures such as linked lists. Examples can identify the semantics of access for each of the plurality of data objects without input from a client application to define boundaries. Examples can identify relationships between the semantics of separate data objects, and in particular, identify a previous relationship associated with a data object having a similar semantic structure. Examples can use that previous relationship to determine optimizations to access the data. Access can be defined by “views” of data, which define how data is accessed and what requirements there are to access the data. Optimizations to the access can be performed based on learned patterns of access, or transformations to adorn existing views of data, or additional new views of data that take into account the identified optimizations.

That is, examples are directed to systems and methods or operation in such systems, where each application requests access to data objects maintained in a database, such as an object store. ML models are developed/used for each application. Each of the ML models receive, as input, relevant I/O parameters/characteristics involved in that application requesting access to data objects. Each of the ML models, based upon the inputs, can output its own respective “predictions” or inferences, i.e., the predicted semantic structure associated with the data objects the application is trying to access. An example machine learning model input may comprise the following information shown in Table 1:

TABLE 1

| Field Name | Possible Values | Data size |
|---|---|---|
| timestamp | 1628640005 seconds since 1970 Jan. 1 | 8 byte |
| | 00:00:00 UTC | |
| application | 0 for POSIX and 1 for DATABASE | 4 byte |
| identifier | | |
| database | WHERE, JOIN, etc. | 4-byte integer |
| operators | | representation |
| POSIX file | readdir( ), unlink( ), etc. | 4-byte integer |
| operations | | representation |
| data | (pool name, object name, distribution key | Various |
| identifier | name, index) = (“k”, “abc”, “def”, 15) | |
| drive offset | 128 byte | 8 byte |
| IO size | 1 MB | 8 byte |

In this example, the ML model may return a “1” to signify that the application involved is a database. A separate ML model may identify what type of database the application is. Based on these findings, the system may predict the semantics of the data within the database as a particular type of database will be associated with one or more certain types of data.

These predicted semantic structures are categorized into certain classes that correspond to options specified/set forth in the application (cache/precompute/etc.) As an example, databases may comprise index data structures which encompass one or more sections of an underlying data structure. The indexes can be precomputed to quickly locate data without searching every section when accessed.

Accordingly, the object store loads the ML model associated with each application. The object store can be specified to work with some maximum number of ML models (according to the object store's compute/memory capabilities). As each application attempts to access its respective, desired data objects from the object store, the ML models are running and (as described above) take in the application parameters and output some predicted semantic structure to the object store. The object store can find the least effective ML model (i.e., the one that can't predict the right semantic structure to access the desired data objects) and remove that model from operation when a new application attempts to access data objects from the data store.

Examples may identify relationships between previously identified patterns and data access and perform optimizations to access data. As an example, a relationship may comprise a similar application identifier to previously stored data, signifying a similar data structure. Optimizations may include prefetching the data to access, caching the data in a higher-level cache to be reused frequently, and/or precomputing by speculatively updating metadata to reflect the upcoming 10, buffer allocation, or other parameters associated with the application and data. Precomputing may also comprise speculatively executing inline data or metadata operations through precision conversion, data filtering, regular expression matching, or other computations specified by the application. In some examples, the models described above may receive the required information to access the data, predict its logical structure, and perform the corresponding optimization. Each predefined semantic structure may correspond to a predefined optimization flow. In examples involving optimization parameters, (e.g., prefetching, which may require a prefetch data offset and stride) the input may be coded with the prefetch category or as a second argument output by the model.

Examples may perform optimizations to the views of the data through learned patterns of access to improve performance or through transformations such as replication. In some examples, accesses may be monitored by an offloading engine while dumping data to a training server periodically. These logs may reveal potential improvements to the views of the data structure based on the characteristics of accessing the data a particular way. As an example, the logs may comprise fixed patterns with a high occurrence rate, which may suggest edits for a developer's dependency chain. That is, a particular developer may be suggested by the log to reduce a dependency chain. As another example, the caching logic may emit hot areas in the storage, suggesting a need to reduce the footprint. Based on these suggestions, potential improvements may comprise modifying the underlying physical layout of the view of the data, reducing the footprint of a view through a compact representation, deleting a view so it is no longer returned, or adding structures such as extra flags attributes, or other adornments. In some examples, offloading logic may automate the actions to fix common issues by a set of rules. As an example, offloading logic may communicate with server logic to modify the underlying layout of data and then access the region in a query whenever the first query in the series is received and categorized as prefetching.

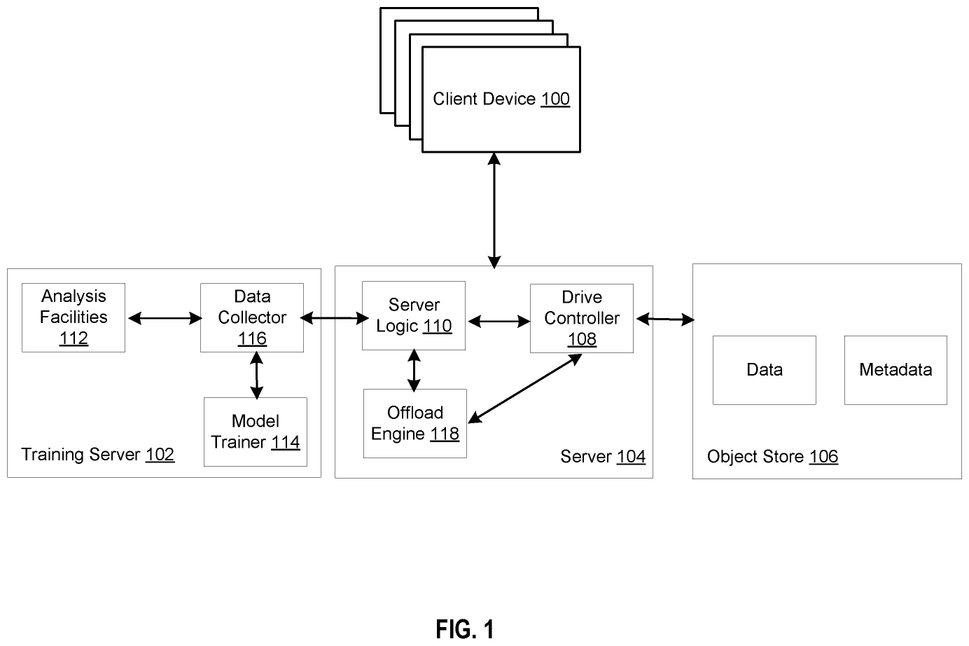

FIG. 1 illustrates an example system interacting with a client device. Client device 100 may submit a query through a client application that transmits the query to server 104. Server 104 may have access to a training server 102 and an object store 106. Server 104 may determine what data object is requested by the query and determine the semantics of that data object based on a plurality of ML models through server logic 110. These ML models can predict various relationships between data objects and predict the semantics of a data object associated with the query to determine an appropriate view of the data object for the client application. As described above, views of data may define how data is accessed and what requirements there are to access the data. An appropriate view of the data would thus satisfy the requirements to access the data such as the correct buffer allocation or 10 requirements. As described above, relationships can include similarities between data objects, including data type, size, attributes, or access protocol. The corresponding prediction may comprise predicting the semantic structure associated with the data objects the application is trying to access. As an example, a ML model may determine that a data object is an image based on its attributes. The ML model may receive information on accessing images based on previous data objects that were identified as images. A ML model may be associated with each application of the client device. The ML model may comprise a recurrent neural network trained with known typical workload traces. The input for these models can be any relevant information, including semantic information from the application, operators in database engines, file operations of the emulated file system, and application-independent information to locate the data physically or logically in the software system of the object store. Applicant-independent information may include data identifiers, data offsets, data size, etc. This information may be passed from the client device or the server to the offload engine, described further below. Any of the above information may be used to determine relationships between data objects. As described above, an input may comprise:

| Field Name | Possible Values | Data size |
|---|---|---|
| timestamp | 1628640005 seconds since 1970 Jan. 1 | 8 byte |
| | 00:00:00 UTC | |
| application | 0 for POSIX and 1 for DATABASE | 4 byte |
| identifier | | |
| database | WHERE, JOIN, etc. | 4-byte integer |
| operators | | representation |
| POSIX file | readdir( ), unlink( ), etc. | 4-byte integer |
| operations | | representation |
| data | (pool name, object name, distribution key | Various |
| identifier | name, index) = (“k”, “abc”, “def”, 15) | |
| drive offset | 128 byte | 8 byte |
| IO size | 1 MB | 8 byte |

The ML model may determine that the application corresponds with a POSIX file system. As POSIX systems comprise a family of standards associated with the semantics, the ML model may determine various semantic characteristics from this identification. Using the example of a POSIX system, the ML model can determine that the system cannot implement caches alone and may include cache consistency protocols.

Server 104 may access object store 106 through drive controller 108 to retrieve the data object associated with the query. Drive controller 108 can interface with object store 106 and receive data and/or metadata from the object store 106. Drive controller 108 can forward that data to server logic 110 and offload engine 118 to process the data prior to sending the data to client device 100. Offload engine 118 and server logic 110 may predict the semantics of the requested data object based on the query as described above and may process the data accordingly to prepare the appropriate view of the data. Object store 106 may comprise data and metadata from one or more databases. Object store 106 may comprise a plurality of data types that can be returned to a client device through the client application. Drive controller 108 serves as the interface between server 104 and object store 106. As described above, server logic 110 may perform optimizations to the views of the data through learned patterns of access to improve performance or through transformations such as replication. The data object can be returned to client device 100 and can also be sent to training server 102 which trains the various ML models to make future predictions of the semantics associated with that data object or a query related to the data object.

Training server 102 may create logs to record the predictions associated with the query. As described above, these logs may reveal potential improvements to the views of the data structure based on the characteristics of accessing the data a particular way. Training server 102 can use analysis facilities 112, model trainer 114, and data collector 116 to train the various ML models for future queries. Data collector 116 can receive processed data from server logic 110 and forward the processed data to model trainer 114. Model trainer 114 can train the plurality of ML models using the processed data so that the models can respond to future inputs similarly. Analysis facilities 112 may provide an interface to the developer to manipulate the data for initial insights. These initial insights may comprise visualization or feature engineering. Analysis facilities 112 may also allow a developer to select and download data to other computers for further analysis and processing. Training server 102 can also periodically retrain the plurality of ML models to update new relationships or predictions. By periodically training the ML models, the ML models stay up-to-date on all previous inputs. The more that the ML models are retrained, the more that relationships can be formed for future input/output operations. Periodically retraining the models may comprise pulling data from one or more servers or pulling logs from the servers so that developers can review the logs to leverage opportunities to add new semantic structures. These logs may be accessed by offloading engine 118 and sent to training server 102 periodically.

As discussed above, one aspect of examples of the disclosed technology involves identifying semantic structures of objects being accessed, and this can be done via offloading. The logic to identify semantic structures can be offloaded to the offload engine instead of a CPU to accelerate the process. In one aspect, offloading can refer to separate machine learning models for each client application. Object store 106 can load a pretrained model dedicated to each client application and add ML models whenever a new client application is added. Object store 106 can support a maximum number of pretrained ML models. When that maximum is reached, object store 106 can remove the least profitable ML model to add a new model. This may be determined based on successful input/output operations or other parameters associated with the particular client application associated with that ML model. In other examples, offloading engine 118 can monitor 10 accesses and periodically move logs recording previous input/output operations. These logs can be transmitted to training server 102 so that developers can review the logs and locate potential new semantic structures. New semantic structures can be added as a class to a particular ML model by the developer.

A second aspect of examples of the disclosed technology involves identifying relationships (through an operator stack that may be split into multiple isolated dynamic regions that operate concurrently) to previously identified structures and performing optimizations to access data. Optimizations may include prefetching the data to access, caching the data in a higher-level cache to be reused frequently, and/or precomputing by speculatively updating metadata to reflect the upcoming 10, buffer allocation, or other parameters associated with the application and data. Precomputing may also comprise speculatively executing inline data or metadata operations specified by the client application. These may include precision conversions, data filtering, regular expression matching, or other computations specified by the application.

Another aspect of examples of the disclosed technology involves performing optimizations to views of the structure of data through learned patterns of access or transformations. In one example, offload engine 118 can move logs to training server 102 as described above. These logs can also provide suggestions on optimizations to views of the data. These suggestions may come from prefetching logic associated with previous 10 requests with fixed patterns and high occurrence, which may suggest to the developer to remove a dependency chain or other parameters associated with the 10 request. Suggestions may also come from caching logic dumps in the storage as needed. Example improvements based on these suggestions may comprise modifying the physical layout of the view of the data, reducing the footprint of a view through more compact representations of the data, deleting views of the data to prevent future uses of suboptimal views, and adding structures such as flags, attributes, or other adornments that can be accessed in addition to the original data. In some examples, the logic may automate the actions to fix common issues by a set of rules. For example, the offloading logic may communicate with server logic 110 to modify the underlying layout of the view of the data. Modifying the layout can be an automated action based on a common attribute of the data so that creating the view of the data occurs quicker.

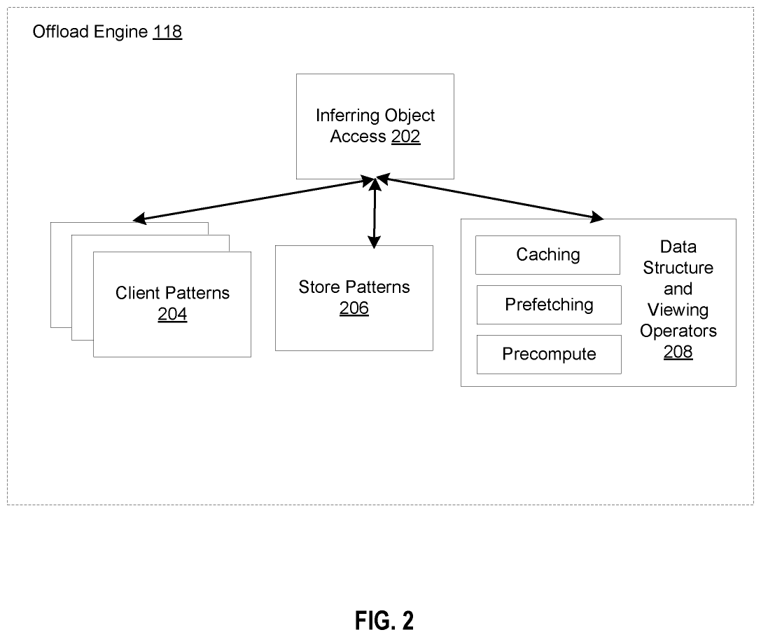

FIG. 2 illustrates an example offloading engine 118 as described above in FIG. 1. Offloading engine 118 predicts relationships between data objects and predicts the semantics of a data object associated with the query to determine an appropriate view of the data object for the client application. This is accomplished by inferring 202 the data object that is being accessed based on the query. This inference may be associated with one or more ML models that can predict the data object based on the query language. This inference can be accomplished based on client device patterns 204 that can be formed from pretrained ML models. As mentioned above, these pretrained ML models can be updated by training server 102 periodically. Once predictions are made, they are stored 206 to be transmitted to training server 102 for purposes of retraining. For purposes of presently viewing the data object, offloading engine 118 can use data structure and viewing operators 208 to optimize the view of the predicted data object. Example operators include Caching, Precaching, and Precompute. Precaching the data can comprise prefetching the data based on access to destination memory locations. Caching may comprise caching the data into a higher-level cache that can be reused or is reused frequently. Precomputing may comprise updating the metadata to reflect the upcoming I/O overhead or buffer allocation. The Precompute operator can speculatively execute inline data or metadata operations such as precision conversion, data filtering, and regular expression matching. These actions may be called to update the views of the data object on the client device. Operators 208 can rely on the inferred object access to allocate memory and compute accordingly.

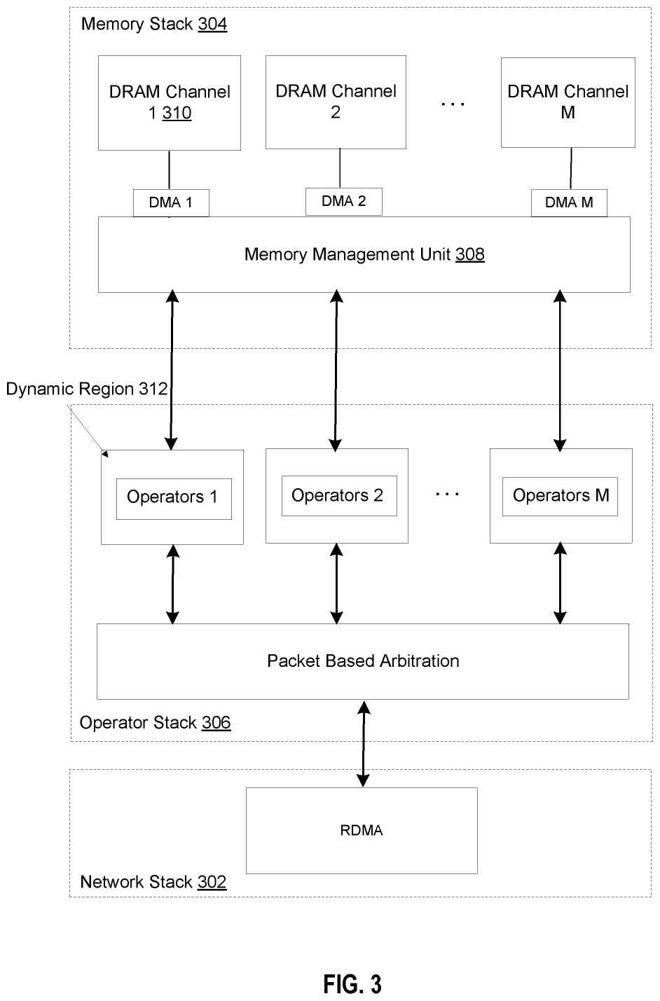

FIG. 3 illustrates an example architecture wherein the systems in FIGS. 1 and 2 can be implemented. The architecture may comprise a memory stack 304, operator stack 306, and a network stack 302.

Network stack 302 may comprise a remote direct memory access (RDMA) connection protocol to manage all external connections. These can include connections to clients, storage nodes and other disaggregated memory nodes. One or more client network connections can flow and associate with one or more dynamic regions in the operator stack. These dynamic regions contain the operators which perform near memory processing for the offloading of operations. Network stack 302 can receive a user query and forward it to the operator stack and the appropriate dynamic region. Each client connection can be associated with a specific queue pair number (e.g., of the form <integer, integer>) which can be used to propagate the request to the correct dynamic region to which the client is assigned. Once in the correct dynamic region, the request can be forwarded to memory stack 304, described further below. Data corresponding to the request can be read from memory stack 304 and passed to the same dynamic region in operator stack 306 where the operators are applied. Resulting data can be sent back to network stack 302 and provided to the client. All arbitration between the clients can be accomplished by a round robin arbitrator on a network packet level, which can provide fair sharing between multiple different clients. In this instance, fair sharing refers to equally distributing network interface bandwidth load among client sessions.

Memory stack 304 can handle all memory allocations, address translations, and concurrent accesses from the dynamic region. This stack houses memory management unit 308 to translate addresses to the memory. Memory stack 304 may comprise multiple channels to facilitate multiple concurrent requests. Example DRAM channel 310 may route to direct memory access to access memory management unit 308. Memory may be allocated to each channel in a striped pattern to optimize the available bandwidth. Memory stack 304 may comprise the object store as described above. The operator stack may interface with memory stack 304 to receive data and metadata from the object store. As described above, the object store may comprise data and metadata from one or more databases. The object store may comprise a plurality of data types that can be returned to a client device through the client application. The object store can load a pretrained model dedicated to each client application and add ML models whenever a new client application is added.

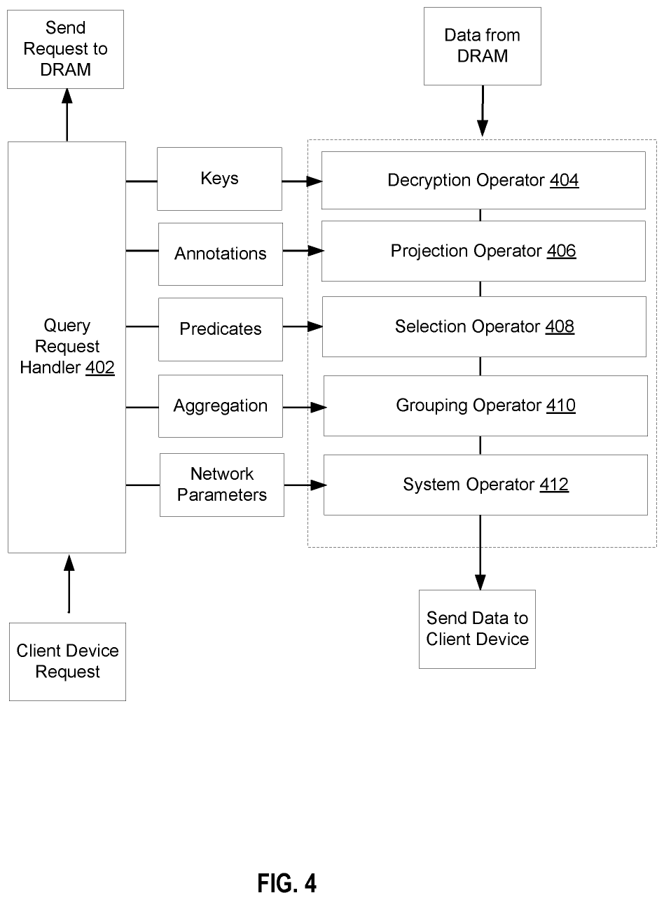

Operator stack 306 may be split into multiple isolated dynamic regions that operate concurrently. Dynamic region 312 will be described below in FIG. 4. Dynamic regions in operator stack 306 can process the data for multiple clients at the same time. Each dynamic region can contain an operator pipeline with a set of operators able to process a range of queries. The data can be processed inside the operator pipelines in a streaming fashion where each stage of the processing is fully pipelined, meaning that different stages of processing inside each operator are occurring simultaneously. This can exploit both spatial parallelization (i.e., the simultaneous execution of tasks by a plurality of processing units) through concurrent dynamic regions and pipelined parallelization, through operator pipelining. Pipeline parallelization can refer to multiple operators depending on each other, while the execution of each operator can overlap with other operators. Both of these greatly contribute to the overall performance of the system. It is through the operator stack that the system can identify relationships to previously identified structures and perform optimizations to access data. Optimizations may include prefetching the data to access, caching the data in a higher-level cache to be reused frequently, and/or precomputing by speculatively updating metadata to reflect the upcoming 10, buffer allocation, or other parameters associated with the application and data,

FIG. 4 illustrates the dynamic region 312 of operator stack 306. As described above, a query can be forwarded to the query request handler in the operator stack through query request handler 402. Query request handler 402 can request the data object associated with the query from the memory stack. This may be accomplished through smart addressing, which can allow data to be read in both row store and column store formats, based on the given request. In some embodiments, data can also be read in graph formats or other representations. The operators used for processing the data object can be precompiled to and can be deployed to dynamic region 312 at runtime. Query request handler 402 can submit the data object to one or more operators depending on the query. FIG. 4 illustrates example operators 404-412 that can process the data object.

Decryption operator 404 may decrypt the data arriving from memory stack 304 if the data is encrypted. For this operation, clients may be required to provide specific keys used for decryption from cipher to plain text. These keys can be provided with the query request. This can allow the system to provide additional levels of security, which is important in modern disaggregated environments.

Projection operator 406 can return a subset of the data object. Projection operator 406 can read a table from the disaggregated memory, parse the incoming data stream based on query parameters describing tuples and their size, and project only the necessary columns into the pipeline for further processing using annotation. This decreases the amount of data provided to subsequent stages and ultimately reduces the amount of overall data movement. Projection operator 406 can use annotation to annotate the tuples with parameters from the requested query. The parameters may state which columns are part of the projection, selection, and grouping phases. Projection operator 406 may annotate the subset of the data object and forward it to selection operator 408.

Selection operator 408 can filter data further to greatly reduce the amount of data ultimately sent over the network, thus reducing I/O overheads. Selection operator 408 can use predicate selection, regular expression matching, vectorization, or other methods to filter the data. Predicate selection can occur by comparing the value of an attribute of the data object against a constant provided in the query. The annotations from projection operator 406 can assist in determining what is evaluated during the predicate matching phase. Regular expression matching can use string matching via multiple parallel engines in operator stack 306. Performance of this operator may be dominated by the length of the string and does not depend on the complexity of the regular expression used. Vectorization can occur by reading data in parallel from multiple channels in operator stack 306. Individual tuples can be emitted to a set of selection operators operating in parallel. The number of parallel operators may be chosen based on the number of memory channels and the tuple width. Vectorization may be implemented for simpler queries that can be parallelized without data dependencies.

Grouping operator 410 can perform aggregation and eliminate repeated column entries before they are sent to the client application and device. Grouping operator 410 can hash the values and preserve the entries in a hash table in the memory stack. In some examples, the hash table can use cuckoo hashing with several hash tables that can be reviewed in parallel. The cuckoo hashing can evict entries from a hash table and insert them into a separate hash table with a different function to reduce collisions. Grouping operator 410 may group data via aggregation and flush data entries from the hash table based on the requested aggregation results. Aggregation can result in specific groupings that can perform a large portion of the processing already in the disaggregated node (which can be determined based on the particular application) without the need to move all the data to the client first and then fully process the data.

System operator 412 can prepare the data filtered by projection operator, selection operator, and grouping operator to be sent to the client device. System operator 412 may also encrypt the data as needed or as requested by the client device. System operator 412 may also pack data based on the annotated columns from projection operator 406, resulting in more efficient utilization of the available network bandwidth. The packing may use an overflow buffer to sustain the line rate. In the case of vectorization, the tuples can be combined from each of the parallel pipelines using a round-robin arbiter. System operator 412 may also comprise a sender unit to produce the correct header information in network stack 302. The sender unit can create RDMA commands without information on the final data size which can allow filtering in the operators where final data size is not known at a time when the request is issued. The sender unit can also forward the data to network stack 302 to be sent to the client application and device.

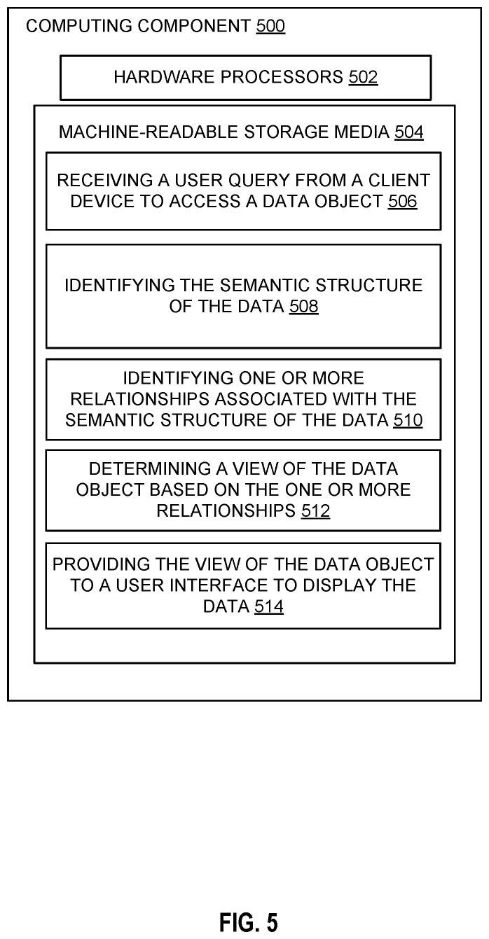

FIG. 5 illustrates an example computing component that may be used to offloading systems in accordance with various examples. Referring now to FIG. 5, computing component 500 may be, for example, a server computer, a controller, or any other similar computing component capable of processing data. In the example implementation of FIG. 5, the computing component 500 includes a hardware processor 502, and machine-readable storage medium 504.

Hardware processor 502 may be one or more central processing units (CPUs), semiconductor-based microprocessors, and/or other hardware devices suitable for retrieval and execution of instructions stored in machine-readable storage medium 504. Hardware processor 502 may fetch, decode, and execute instructions, such as instructions 506-514. As an alternative or in addition to retrieving and executing instructions, hardware processor 504 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 504, may be any electronic, magnetic, optical, or other physical storage device that contains or stores executable instructions. Thus, machine-readable storage medium 504 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 504 may be a non-transitory storage medium, where the term “non-transitory” does not encompass transitory propagating signals. As described in detail below, machine-readable storage medium 504 may be encoded with executable instructions, for example, instructions 506-514.

Hardware processor 502 may execute instruction 506 to receive a user query from a client device to access a data object. As described above, a client device (e.g. client device 100) may submit a query through a client application that goes to a server (e.g. server 104). The server may access an object store through a drive controller to retrieve one or more data objects associated with the query.

Hardware processor 502 may execute instruction 508 to identify the semantic structure of the data. As described above, this may be accomplished through a plurality of ML models. A ML model may be associated with each application of the client device. The ML model may comprise a recurrent neural network trained with known typical workload traces. The input for these models can be any relevant information, including semantic information from the application, operators in database engines, file operations of the emulated file system, and application-independent information to locate the data physically or logically in the software system of the object store. Applicant-independent information may include data identifiers, data offsets, data size, etc. The ML models can use the information provided in the query to determine what data object(s) are being requested.

Hardware processor 502 may execute instruction 510 to identify one or more relationships associated with the semantic structure of the data. The ML models described above can predict various relationships between data objects. The offloading engine (e.g., offloading engine 118) can predict relationships between data by inferring the data object that is being accessed based on the query. This inference may be associated with one or more ML models that can predict the data object based on the query language. This inference can be accomplished based on client device patterns that can be formed from the pretrained ML models.

Hardware processor 502 may execute instruction 512 to determine a view of the data based on the one or more relationships. As described above, the offloading engine can use data structure and viewing operators to optimize the view of the predicted data object. The offloading engine can precache the data by prefetching the data based on access to destination memory locations. The offloading engine can also cache the data into a higher-level cache that can be reused or is reused frequently. The offloading engine may also update the metadata to reflect the upcoming I/O overhead or buffer allocation. Other operators (e.g., operators 208) can rely on the inferred object access to allocate memory and compute accordingly.

Hardware processor 502 can execute instruction 514 to provide the view of the data to a user interface to consume or display the requested data object. As described above, the query can be transmitted through a network stack to an operator and memory stack. When data has been appropriately filtered and grouped, system operators (e.g., operator 412) can pack and send the data through the network stack back to the client device. The client device can consume or display the data on a user interface according to the annotations and groupings provided by the operators in the operator stack. By determining the compute and memory allocations in advance, the client device can view the data while optimizing the memory use and reducing I/O overheads.

Examples of the disclosed technology leverages the stored structure of data and data access semantics to optimize operations on that data. As described above, examples can modify views of the data to tailor to particular data semantics and client applications. Examples can identify subsets of semantics as they apply to particular applications to modify operators that can process data from the object store. Based on these subsets, examples can implement specific data operators that align with object store structures and application semantics. Although examples of the disclosed technology are described in the context of optimizing data access, determining patterns/relationships regarding access data structures can also be used to scan other structures and adorn other structures with generated metadata. Examples can also cache structures anticipated by application, transcode data structures to different formats, and continuously fuel an analytics process that periodically retrains to keep relationships updated.

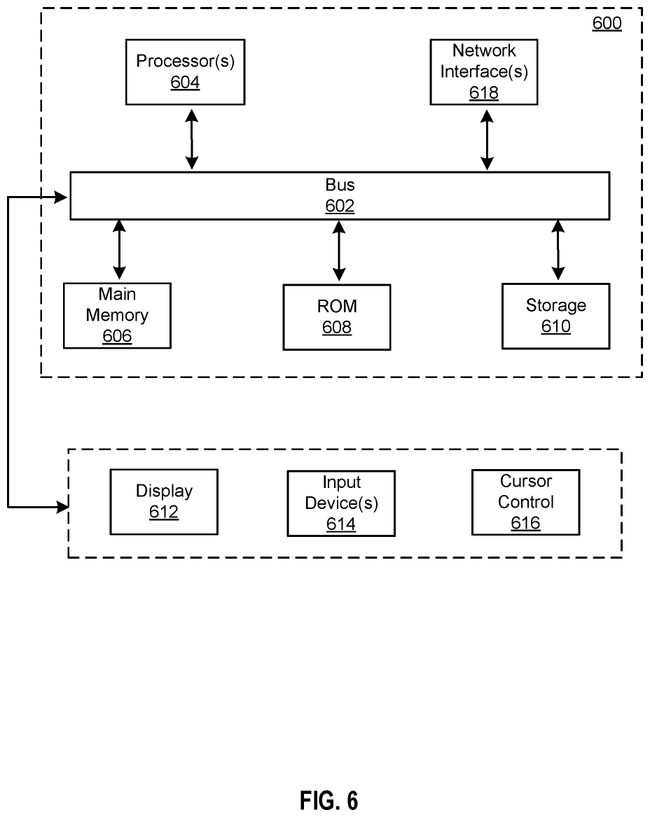

FIG. 6 depicts a block diagram of an example computer system 600 in which various of the embodiments described herein may be implemented. Computer system 600 may comprise architecture as illustrated in FIG. 3 to execute an offloading engine (e.g., comprising a memory stack, operator stack, and network stack). Computer system 600 can be used to identify semantic structures of objects being accessed, identify relationships (through an operator stack that may be split into multiple isolated dynamic regions that operate concurrently) to previously identified structures and perform optimizations to access data. The computer system 600 includes a bus 602 or other communication mechanism for communicating information, one or more hardware processors 604 coupled with bus 602 for processing information. Hardware processor(s) 604 may be, for example, one or more general purpose microprocessors.

The computer system 600 also includes a main memory 606, such as a random access memory (RAM), cache and/or other dynamic storage devices, coupled to bus 602 for storing information and instructions to be executed by processor 604. Main memory 606 also may be used for storing temporary variables or other intermediate information during execution of instructions to be executed by processor 604. Such instructions, when stored in storage media accessible to processor 604, render computer system 600 into a special-purpose machine that is customized to perform the operations specified in the instructions.

The computer system 600 further includes a read only memory (ROM) 608 or other static storage device coupled to bus 602 for storing static information and instructions for processor 604. A storage device 610, such as a magnetic disk, optical disk, or USB thumb drive (Flash drive), etc., is provided and coupled to bus 602 for storing information and instructions.

The computer system 600 may be coupled via bus 602 to a display 612, such as a liquid crystal display (LCD) (or touch screen), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. In some embodiments, the same direction information and command selections as cursor control may be implemented via receiving touches on a touch screen without a cursor.

The computing system 600 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor(s) 604 executing one or more sequences of one or more instructions contained in main memory 606. Such instructions may be read into main memory 606 from another storage medium, such as storage device 610. Execution of the sequences of instructions contained in main memory 606 causes processor(s) 604 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 610. Volatile media includes dynamic memory, such as main memory 606. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 602. Transmission media can also take the form of acoustic or light waves, such as those generated during radio-wave and infra-red data communications.

The computer system 600 also includes a communication interface 618 coupled to bus 602. Network interface 618 provides a two-way data communication coupling to one or more network links that are connected to one or more local networks. For example, communication interface 618 may be an integrated services digital network (ISDN) card, cable modem, satellite modem, or a modem to provide a data communication connection to a corresponding type of telephone line. As another example, network interface 618 may be a local area network (LAN) card to provide a data communication connection to a compatible LAN (or WAN component to communicated with a WAN). Wireless links may also be implemented. In any such implementation, network interface 618 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 618, which carry the digital data to and from computer system 600, are example forms of transmission media.

The computer system 600 can send messages and receive data, including program code, through the network(s), network link and communication interface 618. In the Internet example, a server might transmit a requested code for an application program through the Internet, the ISP, the local network and the communication interface 618.

The received code may be executed by processor 604 as it is received, and/or stored in storage device 610, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 600.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A computing device comprising:
a memory; and
one or more processors that are configured to execute machine readable instructions stored in the memory for performing a method comprising:
receiving a user query from a client device to access a data object;
identifying a semantic structure associated with the data object;
identifying one or more relationships associated with the semantic structure of the data object;
determining a view of the data object based on the one or more relationships; and
providing the view of the data object to a user interface to consume the data.

2. The computing device of claim 1, wherein identifying semantic structure comprises predicting semantic structure associated with the data object.

3. The computing device of claim 1, wherein identifying one or more relationships associated with the semantic structure comprises implementing one or more machine learning models to determine the one or more relationships.

4. The computing device of claim 3, wherein the one or more machine learning models comprise a recurrent neural network trained with known typical workload traces.

5. The computing device of claim 1, wherein determining a view of the data object comprises prefetching the data object, caching the data object in a higher-level cache, or updating metadata associated with the data object.

6. The computing device of claim 5, wherein prefetching the data object comprises speculatively executing inline data or metadata operations through precision conversion, data filtering, or regular expression matching.

7. The computing device of claim 1, wherein the one or more processors cause the instructions stored in the memory to perform a method further comprising sending the data object to a training server to train a plurality of machine learning models.

8. The computing device of claim 1, wherein the one or more relationships comprise data type, data size, data attributes, or access protocol.

9. A method comprising:
receiving a user query from a client device to access a data object;
identifying semantic structure associated with the data object;
identifying one or more relationships associated with the semantic structure of the data object;
determining a view of the data object based on the one or more relationships;
providing the view of the data object to a user interface to consume the data; and
sending the data object to a training server to train a plurality of machine learning models.

10. The method of claim 9, wherein identifying semantic structure comprises predicting semantic structure associated with the data objects the client device is trying to access.

11. The method of claim 9, wherein identifying one or more relationships associated with the semantic structure comprises implementing one or more machine learning models to determine the one or more relationships.

12. The method of claim 11, wherein the one or more machine learning models comprise a recurrent neural network trained with known typical workload traces.

13. The method of claim 9, wherein determining a view of the data object comprises prefetching the data object, caching the data object in a higher-level cache, or updating metadata associated with the data object.

14. The method of claim 13, wherein prefetching the data object comprises speculatively executing inline data or metadata operations through precision conversion, data filtering, or regular expression matching.

15. The method of claim 9, wherein the one or more relationships comprise data type, data size, data attributes, or access protocol.

16. A non-transitory computer-readable storage medium storing a plurality of instructions executable by one or more processors, wherein the plurality of instructions when executed by the one or more processors cause the processors to:
receive a user query from a client device to access a data object;
predict semantic structure associated with the data objects the client device is trying to access;
identify one or more relationships associated with the semantic structure of the data object;
determine a view of the data object based on the one or more relationships; and
provide the view of the data object to a user interface to consume the data.

17. The non-transitory computer-readable storage medium of claim 16, wherein identifying one or more relationships associated with the semantic structure comprises implementing one or more machine learning models to determine the one or more relationships.

18. The non-transitory computer-readable storage medium of claim 17, wherein the one or more machine learning models comprise a recurrent neural network trained with known typical workload traces.

19. The non-transitory computer-readable storage medium of claim 16, wherein determining a view of the data object comprises prefetching the data object, caching the data object in a higher-level cache, or updating metadata associated with the data object.

20. The non-transitory computer-readable storage medium of claim 16, wherein the plurality of instructions when executed by the one or more processors cause the processors to send the data object to a training server to train a plurality of machine learning models.
